(19) United States
(12) Patent Application Publication
(10) Pub. No.: US 2012/0320058 A1
(43) Pub. Date: Dec. 20, 2012

(54) FACILITIES MANAGEMENT SYSTEM AND METHOD

(75) Inventor: Robert Stephen, San Ramon, CA (US)

(73) Assignee: Robert Stephen Consulting LLC, San Ramon, CA (US)

(21) Appl. No.: 13/229,694

(22) Filed: Sep. 10, 2011

Related U.S. Application Data
(60) Provisional application No. 61/496,859, filed on Jun. 14, 2011.

(51) Int. Cl. G06T 17/00; G09G 5/00

(52) U.S. Cl. 345/428; 345/634

(57) ABSTRACT

A system and method for receiving CAD files and converting them into multiple correlated image files for interactive presentation on web-enabled browsers. Additionally disclosed are dynamic overlays showing supplier information related to those objects that allow for supplier information such as fire and safety equipment, security equipment, and the like to be dynamically overlaid with the facility information. The facility information may include a space such as a shop yard, a building, a building and its associated grounds and the like. GPS and online mapping information may be correlated with a building coordinates. A server coupled to supplier information allows for multiple users to share facility information to ensure that building regulations are adhered to. Image information may be coupled to online data sources such as Google Maps, vendor information and social networking sites to complement the image files.

### PRIORITY

This application claims the benefit of provisional application number 61/496,859, entitled “FACILITIES MANAGEMENT SYSTEM AND METHOD” by the same inventor, filed on Jun. 14, 2011.

### BACKGROUND

Modern facilities managers often struggle with the sheer size and complexity of the task. Building regulations, especially concerning the safety and security of the buildings, have become far more complex and there is a greater demand on facilities managers to show compliance with these regulations. This has led to outsourcing many of the processes associated with facilities management. Now the management of a facility often includes managing the quantity and quality of work of suppliers who help with the facilities management.

Facilities management necessarily starts with a complete as possible description of the facility being managed. This information is usually available in the form of computer aided design (“CAD”) files used in the construction of the building. These CAD files include complete layouts of all the floor plans and generally every object that is placed in the facility by a contractor during the construction phase. But the facility manager needs to know more than the layout of the building; in particular, facilities management needs to know the layout of safety equipment, key personnel, and emergency response equipment. To date, software for the management of facilities does not connect well to the design or floor plans of a building in a useful way for the operations of building. Moreover, facilities management software lacks quality, ease of use and reliability.

### SUMMARY

Disclosed herein are systems and methods for receiving computer aided design files and their encapsulated objects and converting them into multiple correlated image files for interactive presentation on web-enabled browsers. Additionally disclosed are dynamic overlays showing supplier information related to those objects that allow for supplier information such as fire and safety equipment, security equipment, and the like to be dynamically overlaid with the facility information. The facility information may include a space such as a shop yard, a building, a building and its associated grounds and the like. Multiple coordinate systems may be employed to allow for GPS information to be correlated with a building coordinates to precisely locate any supplier equipment in the facility. A server coupled to supplier information allows for multiple users to share facility information to ensure that building regulations are adhered to.

Image information may be coupled to online data sources such as Google Maps, vendor information and social networking sites to complement the image files.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 illustrates a functional block diagram of certain elements that may be employed in a facility management system.

FIG. 3 illustrate an image that may be displayed in a browser in accordance with some embodiments of the current disclosure.

FIG. 4 shows three different views of the same floor plan with each view from a different Z (depth) location.

FIG. 5 shows an example of images that may be created by a conversion engine.

FIG. 6 illustrates an example of a dynamic overlay showing several aspects according to the current disclosure.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

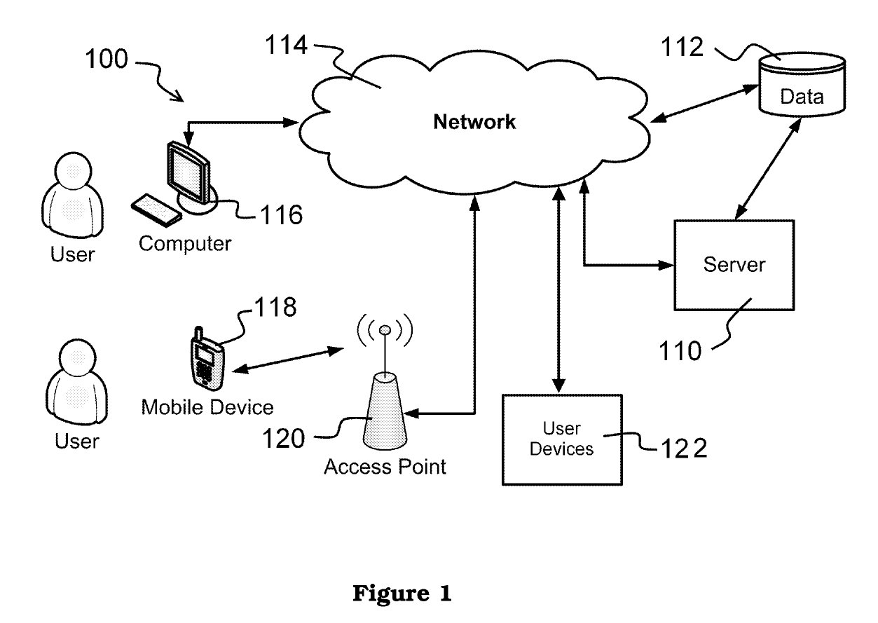

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Image Tiling

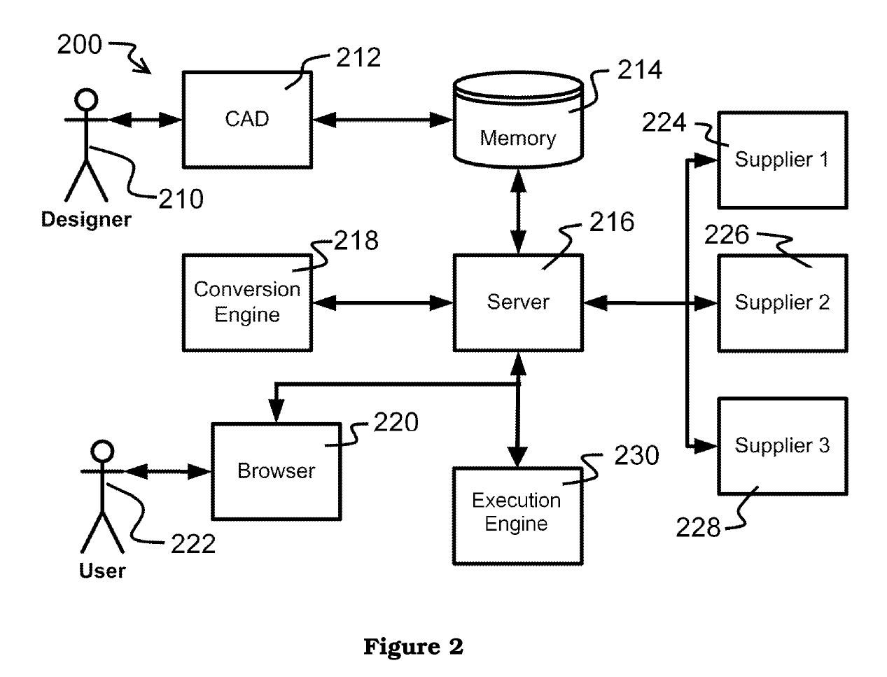

FIG. 2 illustrates a functional block diagram of certain elements that may be employed in a facility management system 200. In FIG. 2 a Designer 210 accesses a computer aided design (CAD) program 212 such as AUTOCAD, VERSACAD, TURBOCAD, and the like. The Designer 210 prepares a design for a CAD object which may be a facility which includes all the facility elements along with other information about the property where the facility is located. For example and without limitation, landscaping, geographic location, fire equipment, and the like. The designer ultimately produces a CAD file. Conventionally, CAD files include building design information such as dimensions, material, entryways, exits, and the like. In certain embodiments the CAD file includes global position location information such as latitude and longitude and may be tied to maps and other geographic information. These maps may be online sources such as Google Earth or Google maps and the like. The CAD software is operable to persist the resulting CAD file in some form of memory 214, or in certain embodiments, the memory may be local and the resulting CAD file is moved to a memory 214. The memory 214 is coupled to a server 216 and the server is programmed with instructions to access the CAD file located on memory 214.

The server 216 is also operable for executing a conversion engine 218. Instruction code for the conversion engine may be stored in memory 214 or memory local to the server. The conversion engine 218 opens the CAD file for extracting information. This information may be free form, using only the references contained in the CAD file, or it may receive additional user input, for example and without limitation, location information in the form of map position, GPS coordinates, and the like. The conversion engine 218 is operable to take that location information and generate a series of image files from a predefined perspective. These image files are structured to interlock such that the images abut each other and provide a view of the CAD object. The images may be bitmapped images such as GIF, JPG or BMP formatted images.

The series of images laid out in a tile work allows a user to view the images and abutting images to see a 2-dimensional view of the CAD object. The tiled images are produced at multiple scales allowing a user to zoom in or out in response to a selection. A higher number of tiled images are created to allow for higher resolution when a viewer zooms in on the images, while for zooming out, fewer image files with lower resolution will suffice. Moreover the images may be animated such as animated GIF (graphics interchange format) images which, when displayed, change from a first image into one or more nested images.

The structure of the CAD files may be in the form of conventional file formats such as Drawing Exchange Format (“DXF”). These file formats may be converted to GIF images using conventional tools. Alternately, 3-dimensional file formats such ACIS solids or SOLIDWORKS files may be rendered and “sliced” into the appropriate cross section. Certain CAD files may be structured as text files describing a collection of objects. These objects may be identified with a unique object ID (“DHandle”) and the identifier used to identify the elements of each object. For example and without limitation, the text file may be structured using the DHandle to persist start point, stop point, layer, color, width, and other characteristics of a line. A collection of lines constitute all or a portion of an object. The object may be an open or closed shape and may be tied to another structural object such as a rooms layer or other design layer.

One possible basic organization of a DXF file is as follows:

HEADER section—Contains general information about the drawing. Each parameter has a variable name and an associated value.
CLASSES section—Holds the information for application-defined classes whose instances appear in the BLOCKS, ENTITIES, and OBJECTS sections of the database. Generally does not provide sufficient information to allow interoperability with other programs.
TABLES section—This section contains definitions of named items.

Application ID (APPID) table

Block Record (BLOCK_RECORD) table

Dimension Style (DIMSTYPE) table

Layer (LAYER) table

Linetype (LTYPE) table

Text style (STYLE) table

User Coordinate System (UCS) table

View (VIEW) table

Viewport configuration (VPORT) table

BLOCKS section—This section contains Block Definition entities describing the entities comprising each Block in the drawing.
ENTITIES section—This section contains the drawing entities, including any Block References.
OBJECTS section—Contains the data that apply to nongraphical objects, for example, those used by AutoLISP and ObjectARX applications.
THUMBNAILIMAGE section—Contains the preview image for the DXF file.
The data format of a DXF may be called a “tagged data” format which means that each data element in the file is preceded by an integer number that is called a group code. A group code's value indicates what type of data element follows. This value also indicates the meaning of a data element for a given object (or record) type. Virtually all user-specified information in a drawing file can be represented in DXF format.

Other structures of the CAD files may be in the form of conventional file formats such as DWG, a binary file format used for storing two and three dimensional design data and metadata. DWG is the native format for several CAD packages including AutoCAD, IntelliCAD (and its variants) and Caddie. In addition, DWG is supported non-natively by many other CAD applications. The conventionally known .bak (drawing backup), .dws (drawing standards), .dwt (drawing template) and .sv$ (temporary automatic save) files are also DWG files.

The file structure of a DWG file may be that as specified by the Open Design Alliance of Phoenix, Ariz. 85028. The Open Design Alliance publishes file specifications for DWG files such as the “Open Design Specification for .dwg Files Version 5.2”. These and other publically available specifications allow for CAD file operations as disclosed herein.

For the example given, the execution engine may have code operable to consume the text information from the CAD files using conventional web scripting languages such as Hypertext Preprocessor (“PHP”). PHP, coupled to a translator, may be used to construct the line objects into image files such as GIF files. The GIF files may be created dynamically when needed by a user, or stored by location identifiers such as building, floor and the like. The image files may also be stored by latitude and longitude and further associated with online map tools such as Google Earth and the like. The image files may be associated with one or more coordinate systems in a structure data store. Even if static images are created and stored, dynamic image creation provides for a user to rotate a CAD object to a desired perspective before translating the image into GIF, thus any perspective view may be created.

These GIF files may be grouped into layer sets, with each layer set having one or more common characteristics. For example and without limitation, a layer set may be comprised of layers at a predetermined resolution or common facility equipment, personnel, or space usage.

In addition to 2-dimensional images, the conversion engine 218 may generate a third dimension of images to allow for visualization of depth. If the first two dimensions are designated as x and y, then the third dimension is designated as z which represents the height of the image. Z images may be exactly the same size as corresponding x-y images, but drawn from a different location in the CAD object. For example and without limitation, if the x-y tiled images represent a floor plan, drawing the z image from a spot 2 feet below the floor could illustrate a crawl space beneath the floor. Z images may also provide a 2-dimensional image, but from a perspective different, say 90 degrees apart, from the x-y images. This may allow for a family of images of the CAD object, each having different resolutions and allowing imaging the CAD object from different perspectives using tile gif files.

CAD objects are supplemented by information from suppliers 224-228. The supplier information includes elements of the CAD object that may not be permanently affixed to the CAD object or are under the management of the supplier. For example and without limitation, the suppliers 224-228 may provide information on security cameras, fire extinguishers, battery operated safety lighting, first aid supplies, safety equipment and the like. The supplier information may be stored locally in memory 214 or alternatively, remotely coupled to the server 216. Supplier information could include location information and information required for maintaining the supplier's equipment. This could include for example and without limitation, expiration date, last service date, scheduled service date, toxicity information, manufacturer information and the like.

The server 216 is operable to aggregate the information from the conversion engine 218 and the supplier information 224-8 and present the information in an interactive environment operated in a network browser 220. The browser 220 may employ different degrees of client-server processing to present the interactive environment to the user 222. This could include client-side scripting and/or plugins for viewing the resulting tiled images.

According to the current disclosure the conversion engine 218 and the server 216 may operate as a web service not requiring a browser. In this aspect a processing device (not shown) connects to the server 216 and submits information about a CAD file. The server 216 then would return a family of tiled GIF images. The process may be controlled through the use of parameters instructing the server 216 and conversion engine 218 how the tiled images should be formed, resolution, size, CAD object information, position and the like. For example and without limitation, a parameter may pass in the DHandle of a CAD object and a parameter indicating a perspective. The server 216, operating with the conversion engine 218 and any necessary suppliers, returns the CAD information in the form of one or more GIF files or other appropriate image files.

An Execution Engine 230 operates to perform other activities in support of the conversion engine. These include control of a user interface, operating processor instructions for accessing suppliers, and other functions as described herein.

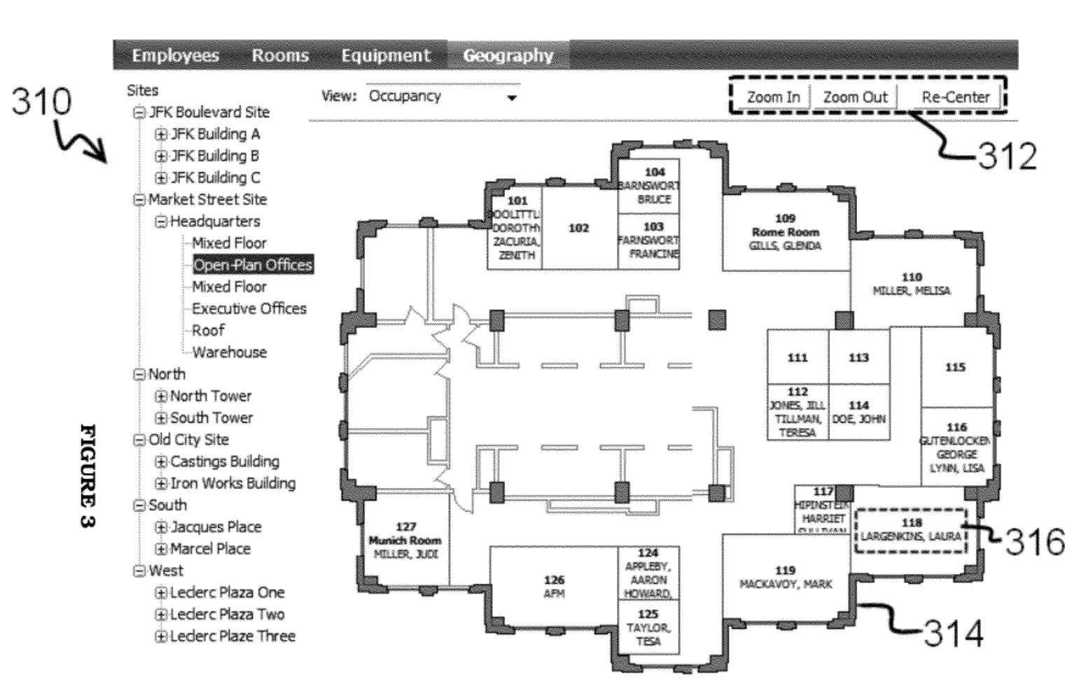

FIG. 3 illustrates an image that may be displayed in a browser in accordance with some embodiments of the current disclosure. In FIG. 3 a menu 310 allows for selecting a location for display. A region 312 contains controls for zooming in and out as well as re-centering the image. An image 314 is displayed. The image in FIG. 3 represents a floor plan of an office converted by a Conversion engine from a CAD file. The image 314 shows external walls and thicknesses as well as relatively thinner internal walls. In FIG. 3 the image 314 is overlaid with room number information and occupant information 316. The room number and occupant information 316 is subject to change and may be supplied by a separate data source than the images of the floor plan.

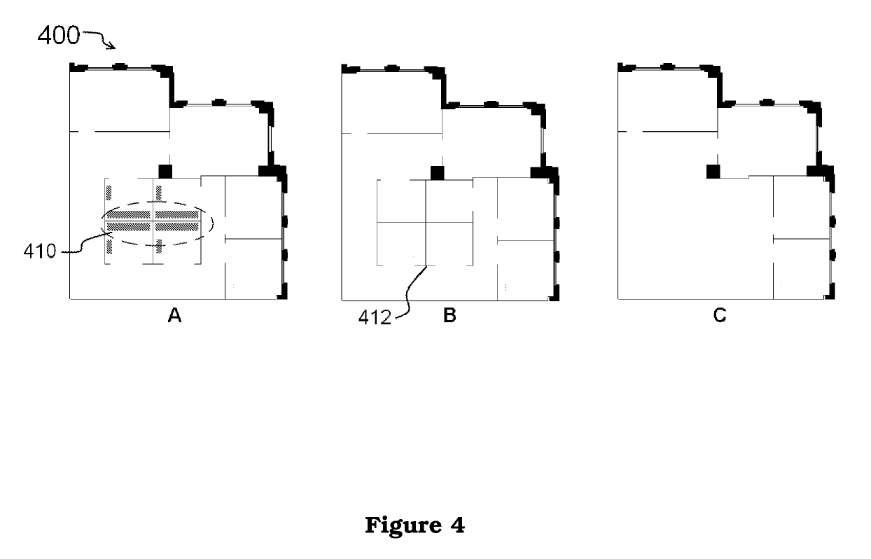

FIG. 4 shows three different views of the same floor plan with each view from a different Z (depth) location 400. FIG. 4A illustrates a floor plan of a furnish office showing furnishing such as desks 410. The graphic of FIG. 4A could be generated by a conversion engine operating to show a full (or “floor”) view of the office space. FIG. 4B shows an image of the same floor as FIG. 4A but with the height raised above the height of the desks. The view of FIG. 4B from a height above the height of the desks shows a view of the floor plan with just the structural elements in place. In particular, the view of FIG. 4B shows the external and internal walls as well as temporary walls 412 such as the type used for working cubicles. FIG. 4C is the same floor plan is FIGS. 4A and 4B, however, drawn from a height above the height of the cubicle walls 412. Thus the view of FIG. 4C shows just the permanent walls. The use of an interactive view of the floor plan illustrated in FIG. 4 allows the user to quickly visualize the space and see the structural elements, the pseudo-structural elements such as cubicles and the office furnishing elements.

One having skill in the art will recognize that the images of FIG. 4 may also be rendered as a perspective, thus providing a third-dimensional aspect to the images.

Global positioning system (GPS) information may be used to indicate the location of information related to the facility. For example and without limitation, a GPS receiver can be used to provide information to suppliers that would be dynamically indicated on a floor plan or facilities layout plan. In addition, latitude and longitude information can be used for translating information from the CAD files by setting the coordinates of the facility. Moreover the location of objects exterior to a building can be referenced by latitude, longitude and height information. In addition to latitude, latitude, and height information, multiple coordinate systems may be used thus linking with measurements derived from the CAD file with the information for other equipment and facilities. A conversion engine may be programmed to translate between the coordinate systems and provide display information in either format.

### Dynamic Icons

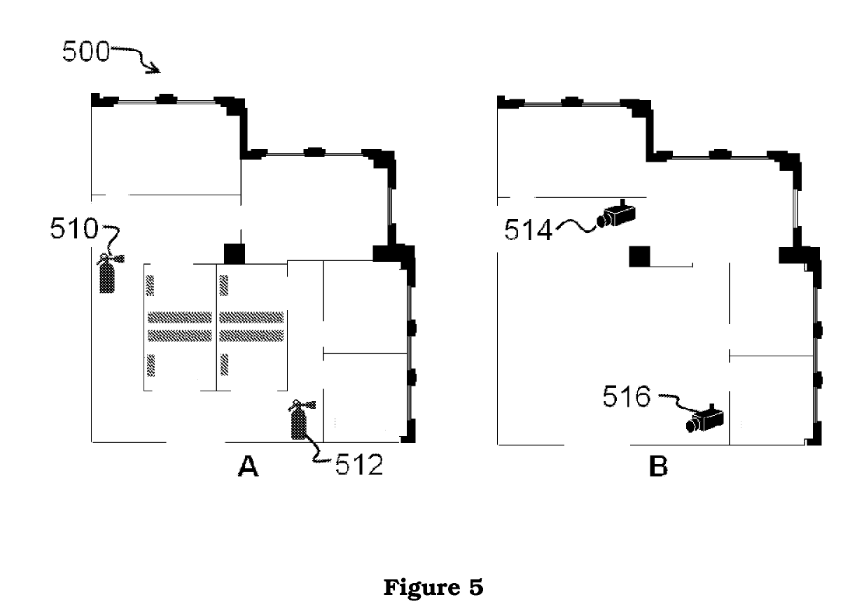

FIG. 5 shows an example of images that may be created by a conversion engine. These images of portrayed to illustrate concepts and are not intended to be limiting in any way. The images of FIG. 5A and FIG. 5B show the same floor plan, however, drawn at different heights. FIG. 5A shows, in addition to the floor plan, the location of fire extinguishers 510 and 512. These fire extinguisher locations and other information about the fire extinguishers comes from suppliers. The suppliers provide information about the most recent inspection, the location, the type of fire extinguisher, the manufacturer of the fire extinguisher, and when the next scheduled inspection is due for that fire extinguisher. Coupling the location and other information about the fire extinguishers with the supplier's database allows the supplier to participate in regular building maintenance activities such as inspecting and replacing fire extinguishers when needed. In certain situations it may be desirable to have the supplier of firefighting equipment responsible for the maintenance of all the fire equipment in the building. This allows for a visual representation of where that fire equipment is located and for the ability of any user of a network-connected browser to access the information and determine the location and how current the firefighting equipment is. Moreover, regulatory agencies can quickly see the status of the facility's firefighting equipment to make sure they comply with local laws and regulations.

Information about the fire extinguishers 510 and 512 may be persisted in a data source owned by the supplier in the form of a table. The table information may include location information in one of several formats. These could be latitude, longitude and elevation, marking the extinguisher x and y coordinates in relation to a standardized image of a floor plan, and the like. Position information may also be stored as required by that CAD format from which the floor plan image is derived. However the fire extinguisher information is stored, the server generates a request for the supplier's data and captures the information about the fire extinguisher then overlays an image of a fire extinguisher icon on the appropriate image file (tiled image) before presenting it to a user. There is no requirement that the image type for the fire extinguisher be the same type as the image generated from the CAD file. Moreover the overlay image need not necessarily be positioned directly on top of the image file, but may also be represented alongside the image file.

FIG. 5B shows an image similar to that FIG. 5A except drawn at a height closer to the ceiling of the office space. Dynamically imposed over this image of the office space are graphics indicating the location of two security cameras 514 and 516. Security cameras are examples of the type of icons that may be generated and are shown only by way of example and should not be considered limiting in any way. Similar to the way fire extinguisher information comes from fire security companies, security camera information may also come from security camera equipment suppliers. The image of FIG. 5B shows a location of the security cameras in relation to the rest of the office. By coupling security camera information to remote data sources, such as a security company, the security company can participate with the facilities management in making sure the security camera information is current, that the cameras are operable, and by making the interactive display of the camera location available to service engineers, it is easier for service engineers to locate the equipment once a defect is indicated. Also If the cameras are defective they can be shown on the display using different color schemes to indicate that these cameras are not operable and this camera needs service as well as other status information. Image information generated by the cameras may also be presented as a dynamic overlay in certain embodiments.

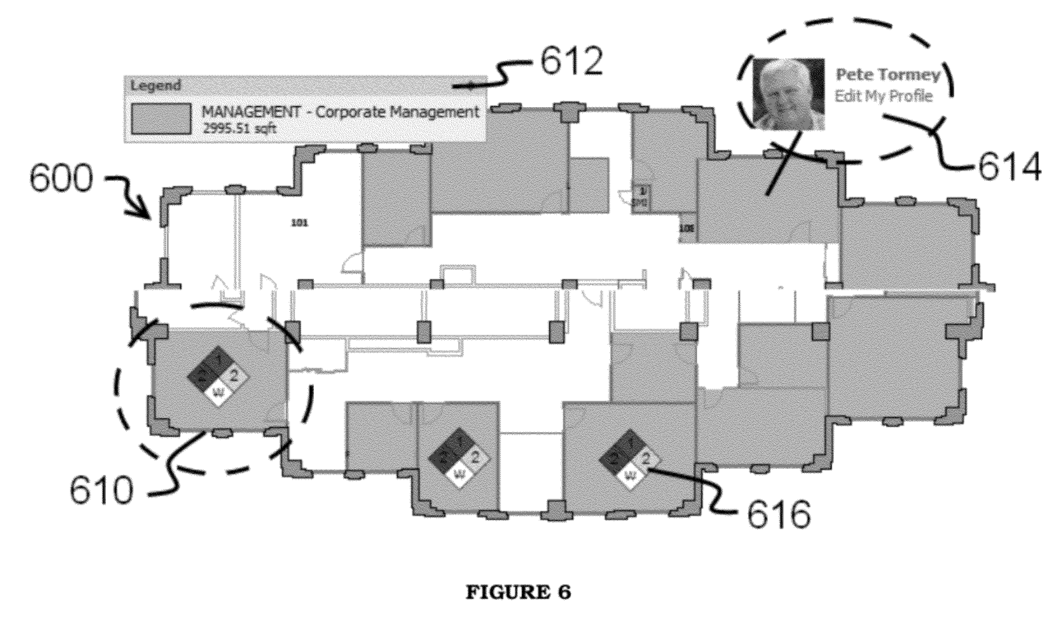

FIG. 6 illustrates an example of a dynamic overlay showing several aspects according to the current disclosure. In FIG. 6 spaces are shown using shading or colors to indicate which parts of a floor plan belong or are assigned to, a specific department 610. In the example shown in FIG. 6 a user might select, using the legend control 612, which department they would like to see and a browser, coupled to a server, would pull the departmental information from a structured data source and render an overlay on top of the floor plan indicating which areas belong to the selected department. Alternatively all departments can be shown by simply color coding or otherwise indicating which areas belong to the specific departments.

Besides indicating which space belongs to certain departments, dynamic overlays can be generated showing the people that are assigned to those departments or using those spaces. For example and without limitation, instead of color coding of otherwise indicating a room with shading, a picture or photograph of the person who uses the office could be placed as an overlay 614. This could be effectuated by selecting picture information from the supplier which has been associated with the specific area of the floor plan. The supplier could be an internal supplier with company employees having photographs in a database, or the supplier could be one of the conventionally available social networking web sites such as FACEBOOK, LINKEDIN, and the like. Overlays may also provide for operations and interactions with social networking sites. For example and without limitation, posts and other information from social networking web sites can be displayed over the area where the person works. For example, if a person in an office posts on TWITTER, those posts may be displayed in the geographical area as overlays to their office space. Taken together, a person using this facilities management tool can see a page that includes the latest social networking information about that person associated with where they work.

Dynamic overlays may include safety indications such as the National Fire Protection Association standard 704. This symbol is the “fire diamond” used by emergency personnel to quickly and easily identify the risks posed by nearby hazardous materials. This is necessary to help determine what, if any, special equipment should be used, procedures followed, or precautions taken during the first moments of an emergency response. By having online, remotely accessible overlay of a facility showing information for emergency responders, the emergency responders may view floor plans and prepare for a response before reaching the location using mobile devices with web browsing abilities. The floor plans may also show routing information to emergency responders and the date the information was collected.

Emergency and safety equipment requires periodic inspections and maintenance. These inspections and maintenance are routinely performed by independent contractors who are in the employ of facilities management. These inspections are often done using wireless remote devices which post the inspection results to data sources belonging to either the facilities management, the supplier or both. In certain embodiments, a server coupled to the supplier's information, can generate facility graphics with overlays showing the most recent inspection date, or when service is due for an area. Inspections may be performed using GPS information on mobile devices to verify the inspector is actually at the location during the inspection and to record exactly where any discrepancies are found.

Supplier information is not limited to that described in the above figures but may also include information concerning exit lights, card access readers, network ports, power receptacles, furniture, air conditioning units, WiFi nodes and other facilities equipment.

### Mapping

Operations may include coupling the facility information to other location sources such as online mapping resources. For example and without limitation, an execution engine may couple to the facility information Google Maps, which would allow for a user to click on a map location and through an iterative process, drill down to a specific location in a facility, a room for example. Each map layer could be tied to a corresponding latitude and longitude value, which in turn is tied to the GIF image files.

In another operation, relocation of assets in a facility may be effectuated by an assignment process, where a person's workspace is moved from a first location to a second location. For example and without limitation an execution engine may provide a list of employees and their locations to a user such as a facility manager. The facility manager may then see the employee's location and what resources are used at that location (i.e. phone, Ethernet, etc). The facility manager may then re-assign the employee to a new location and see a list of what resources are available at the new location. In the event of a discrepancy, the system may generate one or more work orders instructing maintenance workers to adjust the resources at the new location. In the event several employees are moved, the work orders may be consolidated to maximize labor efficiency in the movement of resources. Moreover, through the use of the network, the execution engine may transmit the work orders to other work flow management software and tools.

An execution manager may, through the use of room assignments, allow for one or more users to schedule space for meetings. This provides for locating the nearest meeting space even when participants are located in different facilities, thus minimizing travel distance. In addition the execution engine may operate to show vacant spaces, to provide for categorization of space (storage, maintenance, office, etc.). Users, through appropriate interfaces, may generate custom groups, which in turn, allow for assigning facility resources to those groups. For example and without limitation a project group may be formed and specific laboratory space, storage space and offices are assigned to that project.

### Video

Areas in the facility may also be coupled to audio and/or video by persisting the audio/video in memory coupled to the server or through third-party providers. The audio/video may be associated with the facility or locations in the facility. An execution engine is programmed to serve the video in response to a user interaction with one or more GIF files depicting a portion of the facility. For example and without limitation, the audio/video may provide for:

1. Pictures of the facility to help identify equipment in the space;

2. Instructional material for using equipment in the space;

3. Instructional material for maintaining that portion of the facility, or

4. Audio/visual information about the department or users of the space.

### Visual Bookmarks

Dynamic icons such as those illustrated in FIG. 5 need not come from a supplier. They may be entered by a user as a visual bookmark. In certain embodiments this could involve a user interacting with a web browser to indicate the location and the form of an icon. The server or a servelet operating on the browser determines the location of the icon and persists it in local storage for that user. Alternatively, code operating in the browser may allow the user to grant access to other users to see the location of that icon. Icons can be selected from a menu of icons, or the user can upload an icon of their choice. Once a plurality of icons is entered they can be indexed and displayed to the user as a menu, thus allowing the user to select an icon and go to that location quickly. This may be effectuated by running script in the browser to collect the icon information such as a location and description for the icon. The script may also transmit the icon information back to the server for storage. Persisting the visual bookmark in memory can be done with a table structure indicating the coordinates of the icon, a description of the icon and other pertinent information.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A method comprising:
receiving at a server, design information, said design information including structured data representing at least one facility;
receiving perspective information, said perspective information related to said at least one facility;
rendering that design information to create a plurality of image files, each image file representing a portion of the facility;
associating each image file to at least one other image file, and
presenting at least one of the image files to at least one user,
wherein the image files are structured to interlock such that the image files represent abutting representations of the facility.

2. The method of claim 1 wherein the images are GIF images.

3. The method of claim 1 further including:
receiving resolution information,
wherein each image is rendered at a predetermined resolution.

4. The method of claim 1 further including:
associating one of more of the images to one or more global position parameters.

5. The method of claim 4 further including:
coupling the global position parameters to an online mapping service.

6. The method of claim 1 further including:
categorizing at least one of the image files,
wherein the image file is displayed by category.

7. The method of claim 6 wherein the category includes at least one of a department, a usage, or a resource.

8. The method of claim 1 further including:
coupling at least one of the image files to a vender system, said vender system operative to provide equipment information associated with the portion of the facility represented by the image file.

9. The method of claim 8 wherein the equipment information includes at least one of an inspection date, a replacement date, a category, or an equipment type.

10. The method of claim 8 wherein the equipment includes at least one of a camera, a fire extinguisher, a network port, a telephone port or a power receptacle.

11. The method of claim 1 further including
receiving personnel information, and
presenting the personnel information as an overlay to one or more image files.

12. The method of claim 1 wherein the personnel information is provided by an online social network.

13. The method of claim 1 wherein the image files represent building structure.

14. The method of claim 1 wherein the image files represent at least one of either furniture, electrical wiring, network cabling, exit lights, card access readers, network ports, power receptacles, furniture, air conditioning units or WiFi nodes.

15. One or more processor readable storage devices having non-transitory code embodied on said processor readable storage devices, said code operative to instruct one or more processors to:
receive design information, said design information including structured data representing at least one facility;
receive perspective information, said perspective information related to said at least one facility;
render that design information to create a plurality of image files, each image file representing a portion of the facility;
associate each image file to at least one other image file, and
present at least one of the image files to at least one user.

16. The device of claim 15 wherein the images are bitmap images.

17. The device of claim 15 wherein said code is further operative to:
associate one of more of the images to one or more global position parameters.

18. The device of claim 15 wherein the image files represent at least one of either furniture, electrical wiring, network cabling, exit lights, card access readers, network ports, power receptacles, furniture, air conditioning units or WiFi nodes.

19. The device of claim 15 wherein said code is further operative to:
receive personnel information, and
present the personnel information as an overlay to one or more image files.

20. The device of claim 19 wherein the personnel information is provided by an online social network.
